(19) United States
(12) Patent Application Publication
(10) Pub. No.: US 2016/0362198 A1
(43) Pub. Date: Dec. 15, 2016

(54) Method and system for in-space propulsion based on the principles of inverted sling and separation of propulsion energy from reaction mass

(71) Applicant: Arthur Baraov, Moscow (RU)

(72) Inventor: Arthur Baraov, Moscow (RU)

(21) Appl. No.: 14/735,224

(22) Filed: Jun. 10, 2015

(51) Int. Cl. B64G 1/40; B64G 1/44

(52) U.S. Cl. CPC B64G 1/409; B64G 1/443

(57) ABSTRACT

A method and system for in-space propulsion employing the principle of inverted sling along with the principle of separation of propulsion energy from reaction mass. The method constitutes a novel in-space propulsion concept called rollet propulsion system; space device propelled using the rollet propulsion concept is called a rollet. Rollet wheels are driven electrically by nuclear or solar power while virtually any fluid (water or ordinary air, in particular) can be used as a reaction mass. Being inherently reusable, rollets have potential advantage over chemical rockets in terms of cost efficiency.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR A JOINT INVENTOR

Not Applicable

### BACKGROUND OF THE INVENTION

The invention pertains to spacecraft propulsion methods and systems. Nearly all spacecraft propulsion concepts in existence today are linked—one way or the other—to one of the two ancient warfare devices: the gun and the sling. Chemical, thermoelectric, ion, nuclear thermal and electromagnetic rocket engines all fall into the first category, which for obvious reasons may be called the hot space propulsion concepts. Orbital tower launcher, rolling satellite, orbital skyhook, tether propulsion and gravitational assist are examples of the second category, which lends itself for the title the cold space propulsion concepts.

The hot space propulsion concepts skyrocketed—literally and figuratively—from the nave conceptions of Jules Verne to manned missions to the Moon. In stark contrast to this spectacular success, hardly any of the cold space propulsion concepts—with the notable exception of gravitational assist—made any headway in terms of practical application. Identifying precisely the essence of the conceptual revolution, which has occurred with the transition from Verne's stillborn ideas to the fertile rocket propulsion conceptions of Konstantin Tsiolkovsky and Yuri Kondratyuk, might shed a light on the reasons behind this disparity.

Tsiolkovsky and other pioneers of astronautics recognized early on that Verne's basic idea of flying to space in a huge cannon ball cannot be implemented in practice. There are at least three major problems that make this idea practically useless:
(1) The speed attainable by a cannon ball is limited by the average speed of gas molecules of the chemical explosives, which is far below 11185 m/s—an estimate of Earth's escape velocity that does not take into account the impediment of atmosphere.
(2) The acceleration of a cannon ball—even in the case of impractical cannon with a barrel of a few kilometers long—is so high that there is no chance of surviving it by the travelers.
(3) Even if men could leave the Earth in a cannon ball alive and reach other planets, that would be a one way trip with no hope of return since there is no cannon out there to shoot the cannon ball back.
   These problems are of principal nature, i.e. they cannot be practically resolved. Amazingly, all three problems suddenly disappear with a mere conceptual inversion of Verne's idea—flying in a cannon, rather than in a cannon ball. It is not clear whether Tsiolkovsky recognized that the idea of rocket propulsion was, conceptually, a mere inversion of Verne's idea. But it can be said with confidence that Kondratyuk understood it with crystal clarity; here is a quote from his letter to Prof. Rynin supporting this assertion:

“Contemplating the interplanetary space flight problem, I immediately concentrated [my attention] on the missile method, throwing away artillery one as clearly technically too bulky, and most importantly—not promising return to Earth, and therefore meaningless . . . I moved on to a combined missile and artillery options: gun fires a ball, which in turn is a gun that fires a ball and so on; the calculations, once again, revealed the monstrous size of the required initial cannon. Then I turned around the barrel of the secondary gun (i.e. the first ball), converting it into a permanent member of the rocket, and forced it to shoot in the opposite direction with smaller balls, i.e. I have increased the active mass of the charge at the expense of the passive masses—and again I got a monstrous value for the mass of the rocket gun, but then I noticed: the more I increase the mass of the active part of the charge at the expense of the passive masses (balls), the better become the formulas for the mass of the rocket. From that point, it was not difficult to logically move to pure thermochemical rocket, which can be regarded as a flying cannon continuously shooting with blank cartridges.”

These words of Kondratyuk leave no doubt that from the conceptual viewpoint rocket propulsion is nothing but propulsion based on the principle of inverted gun. Inverting Verne's conception of space propulsion was a revolutionary idea that turned, in relatively short period of time, the hot space propulsion concepts from theoretical impossibility into resounding practical success.

This suggests an answer to the question why the cold space propulsion concepts did not take off the ground in more than one hundred years passed since the publication of the famous rocket equation. The three major problems that make space travel in a cannon ball impossible are basically the same problems that are making the idea of space travel in a sling ball useless. But we have now a powerful hint as of how to turn the idea of sling-based propulsion from a farfetched theoretical concept into a sound practical solution, which can be implemented even with today's technology and with materials already available commercially. The hint is to invert the idea of sling-based propulsion in the same way as Jules Verne's idea of gun-based propulsion was inverted by the pioneers of thermochemical rocketry. To echo Kondratyuk, it is not difficult now to logically move to the concept of rollet propulsion: A system of slings—two large 8-spoke-wheels spinning in opposite directions in the simplest implementation—releasing inert fluid from the tip of each spoke-tube in a continuous succession of short pulses wherein the expulsion of reaction mass is orchestrated in such a way as to convert rotational motion of the wheels into translational motion of the wheeled spacecraft. The wheels, driven electrically by nuclear or solar power, would spin at a rate that results in an exhaust velocity of several km/s. Spoke material and its design would assure structural integrity under a demanding tensile stress due to the centrifugal forces and a bursting pressure of the fluid flowing through the hollow interior of each spoke-tube.

Seeing the flying sling itself—rather than the object thrown by a stationary sling—as a spacecraft device is the essence of the idea behind inverting the sling-based propulsion. This conceptual inversion is likely to have implications and practical consequences comparable to that of the transition from the impossible idea of flying in a cannon ball to the conception of thermochemical rocket “as a flying cannon continuously shooting with blank cartridges.”

### BRIEF SUMMARY OF THE INVENTION

A new propulsion method and system based on the principles of inverted sling and separation of propulsion energy from reaction mass is proposed. The method and system can be used to propel space devices that are already in space: satellite transfer from LEO to GSO, delivery of cargo capsule from LEO to an orbit around the Moon, interplanetary manned missions, etc.

The method constitutes a novel in-space propulsion concept which herein is called rollet propulsion for short. Any space device propelled using the rollet propulsion concept is called a rollet device, or a rollet. The rollet is driven by electricity generated from nuclear or massless solar power that is plentiful at least within the confines of Mars' orbit and available in space around the clock. In the rollet propulsion system, virtually any fluid water or ordinary air, for example—can be used as a reaction mass. Unlike ordinary chemical rockets, rollets are inherently reusable devices, which is an important cost saving feature of the rollet propulsion system.

### BRIEF DESCRIPTION OF THE DRAWINGS

FIG. 1A depicts overall view of a hydraulic rollet: 1 and 2—rollet wheels rotating in the opposite directions at the same rate; 3—shaft on which the rollet wheels are mounted; 4—propellant tank; 5—spacecraft containing useful load and various structural elements (living cabin, cargo, electric motor, control devices, etc.) The shaft and the spacecraft are both solidly attached to the propellant tank.

FIG. 1B depicts cross-sectional view of the rollet wheel with its eight spokes. Each spoke is a circular tube of variable thickness with inner and outer diameters tapering toward the tip. Liquid fuel is delivered from the propellant tank to the spoke-tubes via the hollow interior of the shaft.

FIG. 2A depicts fuel jet release schedule from a spoke of the rollet wheel 1 in the case when hydraulic nozzle axis is tangential to the wheel's circumference (FIG. 3). The fuel ejection takes place from that spoke of the wheel 1 which, at the given instant of time, forms an angle with the flight direction in the range of π/2±π/8 (90°±22.5°).

FIG. 2B depicts fuel jet release schedule from a spoke of the rollet wheel 2 in the case when hydraulic nozzle axis is tangential to the wheel's circumference (FIG. 3). The fuel ejection takes place from that spoke of the wheel 2 which, at the given instant of time, forms an angle with the flight direction in the range of −π/2±π/8 (−90°±22.5°).

FIG. 3 depicts the spoke tip region in the case when the hydraulic nozzle axis is perpendicular to the spoke axis: 6—spoke cap in the form of a thick hemisphere; 7—hydraulic nozzle of conoid profile; 8—exhaust control valve. This asymmetric configuration delivers the highest efficient exhaust velocity but it comes with a price: it is technologically difficult to implement and less reliable then symmetric arrangement (FIG. 4).

FIG. 4 depicts the spoke tip region in the case when hydraulic nozzle and spike axes are aligned: 6—spoke cap in the form of a thick hemisphere; 7—hydraulic nozzle of conoid profile; 8—exhaust control valve. This symmetric configuration is preferable from the engineering point of view but it comes with a price: effective exhaust velocity is √2 times less than that what can be attained with the asymmetric nozzle configuration of FIG. 3.

FIG. 5A depicts fuel jet release schedule from a spoke of the rollet wheel 1 in the case when the hydraulic nozzle axis coincides with the spike axis (FIG. 4). The fuel ejection takes place from that spoke of the wheel 1 which, at the given instant of time, forms an angle with the flight direction in the range of 3π/4±π/8 (135°±22.5°).

FIG. 5B depicts fuel jet release schedule from a spoke of the rollet wheel 2 in the case when the hydraulic nozzle axis coincides with the spike axis (FIG. 4). The fuel ejection takes place from that spoke of the wheel 2 which, at the given instant of time, forms an angle with the flight direction in the range of −π/4±π/8 (−135°±22.5°).

### DETAILED DESCRIPTION OF THE INVENTION

In the rollet propulsion system, virtually any fluid can be used as a reaction mass. Herein the reaction mass is referred to interchangeably as “propellant” or “fuel”, notwithstanding the word “fuel” is somewhat misleading in the rollet propulsion context for it is not something to be burned—it is merely a reaction mass to be ejected from the rollet device in one direction to push the device in the opposite direction.

Hydraulic rollet is a rollet device using water as a propellant. It is equipped with two large wheels of radius, R, rotating in the opposite directions at the same angular velocity, ω, (FIG. 1A). The wheels are driven electrically by solar or nuclear power. Each wheel has 8 spokes and no rim; the spokes are tapered tubes of circular cross section made of high strength material (FIG. 1B). Spinning massive wheels with water-filled spoke-tubes act both as centrifugal pumps and mechanical energy storage devices. The propellant is sucked from the fuel tank into the spoke-tubes through the hollow interior of the shaft on which the wheels are mounted, and then exhausted at the spoke end in the tangential or radial direction with speeds of a few km/s. The fuel tank is a large cylinder closed with hemispheres at both ends. The tank is equipped with a donut-shaped rubber balloon around the shaft. After the tank is filled with water, the balloon is pumped with air at a pressure just high enough to force the liquid into the spoke-tubes; in zero gravity conditions, small fractions of 1 atm will be enough to push the fluid from the fuel tank into the spoke-tubes. The shaft is passing through the fuel tank cylinder, with the shaft and tank axes aligned. The two wheels on the shaft are spinning in the opposite directions, and the tank is solidly attached to the shaft. The wheels are mounted at the ends of the shaft. Having a few meters of distance between the wheels, the rollet device is able to change easily the direction of flight by controlling the fuel consumption independently for each wheel. The spacecraft, which contains all useful load and various structural elements (living cabin, cargo, electric motor, solar panels, etc.), is solidly attached to the propellant tank (FIG. 1A).

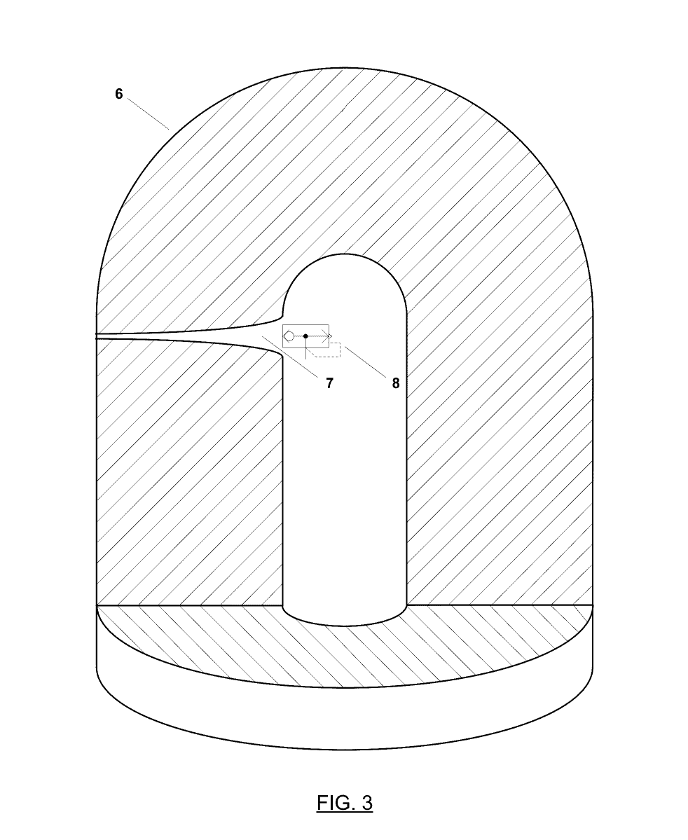

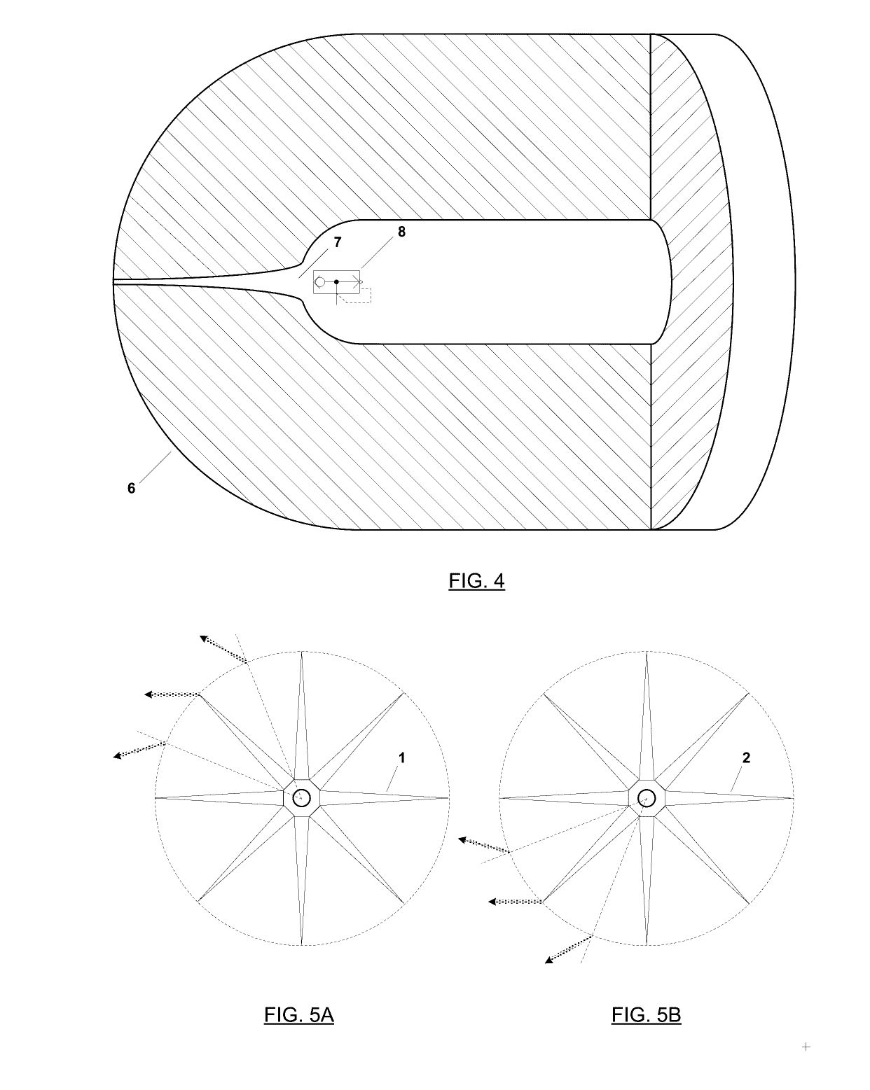

To attain highest possible exhaust velocity, each spoke is equipped at the end with a hydraulic nozzle of conoid profile with two possible configurations (FIG. 3 and FIG. 4). Fluid expulsion through the exhaust nozzle is controlled by a valve located near the nozzle inlet. Depending on the target design parameters, it might be necessary or desirable to have an additional valve near the base of the spoke, both valves working in sync to provide for a smooth, safe, and well-controlled operation of the rollet device.

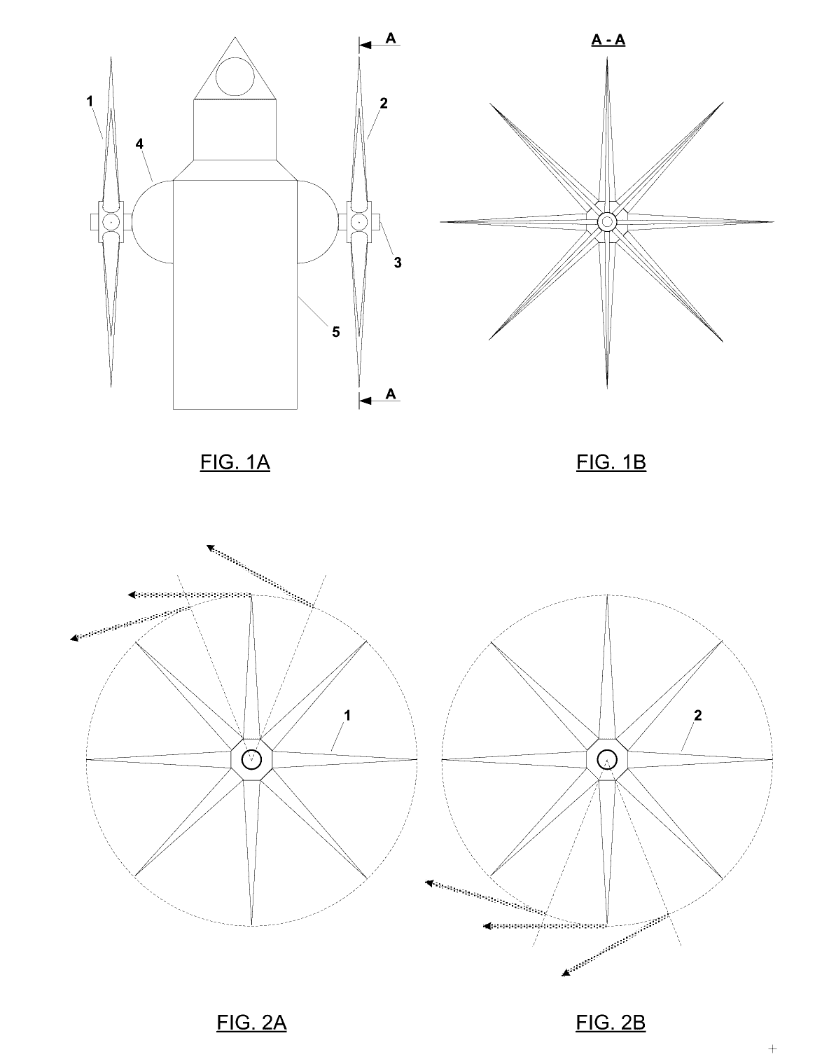

When propulsion is on, fuel is ejected from two and only two spokes at any given instant of time—one spoke from each wheel (except for the moments of flight direction change, of course, when asymmetric fluid consumption by the two wheels would be required). With the tangential configuration of the hydraulic nozzle (FIG. 3), fuel ejection takes place from that spoke of the first wheel, which forms an angle with the flight direction in the range of π/2±π/8 (FIG. 2A), and from that spoke of the second wheel, which forms an angle with the flight direction in the range of −π/2±π/8 (FIG. 2B). With the radial configuration of the hydraulic nozzle (FIG. 4), fuel ejection takes place from that spoke of the first wheel, which forms an angle with the flight direction in the range of 3π/4±π/8 (FIG. 5A), and from that spoke of the second wheel, which forms an angle with the flight direction in the range of 3π/4±π/8 (FIG. 5B). Thus, the streams of propellant ejected from these two spoke-tubes are closely collimated with the flight direction. Consequently, the kinetic energy of rotational motion of heavy wheels and the potential energy of highly compressed water inside the spoke-tubes are converted into the energy of translational motion of the spacecraft. The effective exhaust velocity, Vₑ, which is defined as the velocity of the reaction mass relative to the spacecraft rather than to the spoke tip, is a combination of the fuel discharge velocity at the nozzle outlet, V_{d}, and the tangential speed of the nozzle itself, Vₜ:

Vₑ=C_{θ}(V_{d}+Vₜ) (1)

where C_{θ} is a factor accounting for the fact that fuel jet collimation is not perfect. Obviously, C_{θ}=sin(π/8)/(π/8), therefore, the loss of thrust due to the lack of ideal collimation is 2.5%.

To put it differently, the effective exhaust in the rollet propulsion system is a combined effect of hydraulic and sling actions.

Swapping of said angle ranges for the rollet wheels will obviously reverse the direction of fuel jets, thereby causing deceleration of the spacecraft instead of acceleration. In general, asymmetric fuel release (for instance, suspending fuel expulsion from the spoke-tubes of one or the other wheel) is a way of controlling the flight direction.

It is plain that Vₜ=ωR. However, it is not so obvious that V_{d} is also equal to ωR, that is V_{d}=Vₜ, so, let us elaborate on this. Fully developed turbulent flow of water with a Reynolds number over 10⁴ (which is expected to be a typical operating condition for any hydraulic rollet, see Table 3) can be described fairly well as a flow of incompressible inviscid fluid. Fluid pressure distribution along the spoke axis, p(r), is determined then by the equation of static equilibrium in the rotating reference system of the corresponding wheel:

dp(r)=ρ_{f}ω²rdr (2)

where ρ_{f} is the fluid density.

It shall be noted here that the equation (2) is valid regardless whether the tube is of uniform cross-sectional area or not, provided the acceleration of fluid along the tube axis is negligibly small compared to the centripetal fluid acceleration, which is always the case in the operation of hydraulic rollets. The solution of this equation is:

p(r)=ρ_{f}ω²r²/2 (3)

In particular, the fluid pressure has its maximum value reached at the spoke tip; it is convenient to present the peak pressure in terms of spoke tip velocity:

p_{R}=ρ_{f}Vₜ²/2 (4)

With the liquid being released into the vacuum of space through the hydraulic nozzle of conoid type, the fuel jet velocity is found using Bernoulli's equation:

V_{d}=√(2p_{R}/ρ_{f}) (5)

Substituting p_{R} from (4) into (5) concludes the proof that, indeed, V_{d}=Vₜ. Thus, the effective exhaust velocity (1) in the hydraulic rollet propulsion system boils down to a simple function of the tip velocity:

Vₑ=2C_{θ}Vₜ (6)

### Hydraulic Rollet Equations

In this subsection, the equations of the rollet wheels rotation and translational motion of the rollet device itself as a whole are derived in the more complex case of asymmetric nozzle configuration (FIG. 3). The list of main notations to be used in the derivation is given below:

N—number of rollet wheels (N =2);

m—current mass of the fuel in the fuel tank (does not include mass of fluid in spoke-tubes);

M_{w}—mass of one rollet wheel (includes mass of fluid in eight spoke-tubes of the wheel);

I_{w}—moment of inertia of one rollet wheel;

Mₛ—mass of the spacecraft (includes mass of empty fuel tank);

M—overall current mass of the rollet device (M=m+M_{w}N+Mₛ);

V—translational velocity of the spacecraft;

P—power output of the electric motor driving the rollet wheels;

Dₙₒ—inside diameter of the hydraulic nozzle at its outlet;

Aₙₒ—area of the hydraulic nozzle outlet (Aₙₒ=πDₙₒ²/4);

A_{f}—cross-sectional area of the hollow interior of the spoke-tube;

Aₛ—area of the ring-shaped cross section of the spoke-tube;

ρ_{f}—fluid density;

ρₛ—spoke material density;

t—current instant of time.

The torque applied to the spinning rollet wheel is comprised of three components:

T=Tₚ+T_{c}+Tₜ (7)

where Tₚ is the torque by the electric motor, T_{c} is the torque by the Coriolis force of the fluid flow through the spoke-tube, and Tₜ is the torque by the fuel jet from the nozzle:

Tₚ=P/(ωN) (8)

T_{c}=−∫₀^{R}2ωu(r)rρ_{f}A_{f}(r)dr (9)

Tₜ=(RVₜ/N)dm/dt (10)

Here u(r) is the fluid velocity relative to the tube. According to the continuity equation for incompressible fluid flow, we have:

u(r)A_{f}(r)=V_{d}Aₙₒ (11)

Substituting (11) into (9) with subsequent integration shows that T_{c}=Tₜ:

T_{c}=−∫₀^{R}2ωρ_{f}V_{d}Aₙₒrdr=−ωρ_{f}V_{d}AₙₒR²=(RVₜ/N)dm/dt=Tₜ.

Consequently, the following system of equations describes fully the rollet operation (rotation of the rollet wheels, translational motion of the rollet device as a whole, and fuel ejection, respectively):

P/(ωN)+(2RVₜ/N)dm/dt=I_{w}dω/dt

−Vₑdm=(m+NM_{w}+Mₛ)dV

dm=−ρ_{f}V_{d}AₙₒNdt (12)

Taking into account that M=m+M_{w}N+Mₛ, dm=dM, and Vₑ=2ωRC_{θ}, the system of differential equations (12) is rendered in a lucid form:

Pdt+2(ωR)²dM=I_{w}Nωdω

−2ωRC_{θ}dM=MdV

dM=−ρ_{f}ωRAₙₒNdt (13)

There are two different regimes of operating a rollet device. The first one—the continuous regime—is wherein the spin rate of the rollet wheels is maintained at the highest level compatible with the requirements of safe operation of the device. This level is determined mainly by the strength of the spoke material. The continuous regime is the preferred way of operating any rollet device for it maintains the exhaust velocity at the highest level attainable by the device. Since the angular velocity of the wheel rotation, ω₀, is constant in the continuous regime, the system of equations (13) has a simple solution:

V=2ω₀RC_{θ} ln(M₀/M) (14)

Here M₀ is the overall initial mass of the rollet device with the tank full of propellant. This is the equivalent of the well-known rocket equation, with exhaust velocity being taken equal to 2ω₀RC_{θ}. The power of the electric motor required for operating the rollet device in the continuous regime is then:

P=2ρ_{f}AₙₒN(ω₀R)³ (15)

Depending on the rate of electricity generation from solar or nuclear power, operating the rollet device in the continuous regime may or may not be feasible. The higher the desired rollet thrust, the higher propellant consumption rate; and the higher propellant consumption rate, the higher electricity generation rate that is required to keep the wheels rotating at the same undiminished rate.

Depending on the desired thrust, generating electricity from solar power at the rate that would be sufficient for operating a given rollet device in the continuous regime may present a technically challenging task (Table 2). If that is the case, using nuclear power as the source of energy for driving the rollet device might be a solution.

There are two other approaches that would still allow operating rollets in the continuous regime at the highest effective exhaust velocity attainable by the device:

(1) Consume propellant at reduced rate to match it with the rate of electricity generation from solar power;

(2) Use a pair of large wheels made of light and strong material for storing solar energy accumulated beforehand in the form of kinetic energy of rotation. If the diameter of these “mechanical batteries” is large enough (hundreds of meters), the highest attainable wheel rotation rate, which is determined ultimately by the tensile strength of the material, could be as low as one rotation per second, or even less; therefore, they would make perfect batteries since there would be nearly no energy loss on friction at such low rates of rotation in zero-gravity environment. These mechanical batteries could be recharged at spare time by solar power. Since the mass of these energy storage mechanical devices is added to the overall mass of the rollet, the efficiency of these batteries is determined by specific strength (strength-to-density ratio) of the material they are made of. At high enough levels of specific strength, the efficiency of these mechanical batteries may surpass that of the ordinary electrical batteries.

If neither of these two approaches is available or desirable for whatever reason, there is still a way of operating the rollet device near its highest attainable efficiency. The term efficiency here refers to the efficiency of fuel utilization—the higher the operating exhaust velocity, the higher the efficiency of fuel utilization by the rollet device. This is achieved by interrupting fuel consumption at regular intervals, i.e. operating the rollet in the pulse regime as described next.

The rollet wheels are pretty heavy and they have a lot of energy accumulated in the form of both kinetic energy of rotating wheels and potential energy of highly compressed fluid in the spoke-tubes. Therefore, even with an arbitrary low rate of electricity generation from solar power, the wheels will maintain their spin rate almost undiminished for some period of time. As soon as the spin rate drops by 2.5% the fuel consumption is suspended, and the wheels are given the opportunity to regain their original spin rate, ω₀, from the electric motor before the ejection of propellant is resumed. This cycle is then repeated. This way, the effective exhaust velocity is kept near its highest attainable value, 2ω₀RC_{θ}, whenever propellant ejection is taking place. That is the idea behind the pulse regime—it makes possible operating rollets near their maximum efficiency under the conditions of low rate of electricity generation from solar power.

Rollet propulsion system operating in the pulse regime is fundamentally different from the rocket propulsion in one important respect. According to the rocket equation, velocity change depends on two parameters only—the exhaust velocity and the mass ratio, i.e. the velocity gain does not depend on the exact schedule of fuel consumption: we may spend all available propellant in a few minutes or in a few days—the velocity increment would still be the same. This is not always the case in the rollet propulsion system. With the rollet device operating in the pulse regime, velocity change dependents on the way propellant is consumed. To attain the highest possible efficiency, fuel consumption should be administered with regular interruptions. Consumption is suspended as soon as the spin rate of the rollet wheels drops by no more than 2 or 3 percent. Before the fuel consumption may resume, the electric motor should be given enough time to bring the spin rate of the wheels back to the maximum operating value, ω₀; the cycle is then repeated.

Operating the rollet device in the pulse regime requires interrupting and resuming propellant expulsion at exactly calculated and measured intervals, wherein the rotation rate of the wheels is slightly decreasing in the course of each session of fuel consumption. A precise control of the fuel consumption, assumed by the pulse regime, requires the knowledge of the solution of the above system of differential equations (13) in the general case of variable ω.

Substituting dt=−dM/(ρ_{f}AₙₒNωR) into the first equation of the system (13) with subsequent integration yields the following functional relation between the drop of spin rate, Δω=ω₀−ω, and the fuel consumption, ΔM=M₀−M:

Δω/ω₀=1−[η+exp(−μΔM/M₀)]^{1/3} (16)

This is the main equation of the rollet propulsion system; it can be presented also in the following equivalent form:

ΔM/M₀=−(1/μ)ln[(1−Δω/ω₀)³−η] (17)

Here μ≡6R²M₀/(I_{w}N), η≡P/[2ρ_{f}AₙₒN(ω₀R)³], and index zero indicates the value of the corresponding variable at the start of the current propellant ejection streak.

Efficient exhaust velocity is the most important characteristic of hydraulic rollets, just like exhaust velocity of combustion products is the most important characteristic of chemical rockets. The best chemical rockets can attain exhaust velocities up to 4500 m/s; bipropellant liquid rockets cannot do markedly better than that even theoretically.

As we have mentioned earlier, the upper limit for the efficient exhaust velocity that can be attained in the rollet propulsion system is determined by the maximum spin rate of the wheels, which, in turn, is determined by the requirements of safety operation of the rollet device given the tensile strength, o⁻_{T}, of the spoke material. We examine next this limit in practical and theoretical terms, and compare it to that of the chemical rockets.

### Design of the Spoke-Tube for Maximal Load-Carrying Capacity

Circular cylinder of uniform cross-sectional area is geometrically the simplest form the spoke-tube could have. With the wheels rotating at a fixed angular velocity, ω, tensile stress distribution along an empty spoke-tube of uniform cross-sectional area, Aₛ, is found easily. The equation of motion for a small element enclosed between two adjacent cross sections is as follows:

−Aₛdσ=ρₛAₛω²rdr (18)

With the boundary condition, σ|_{r=R}=0, this equation has a simple solution:

σ(r)=ρₛω²(R²−r²)/2 (19)

The highest velocity, the tip of the pipe may attain without breaking, is then a function of the tensile strength, σ_{T}, of the material and its density, ρₛ:

V_{c}=√(2σ_{T}/ρₛ) (20)

This is a property of the material, which plays an important role in the context of the rollet propulsion system; it is called henceforth the “characteristic velocity” of the material.

Tapering the internal and external diameters of the spoke-tube is a way of increasing its load-carrying capacity. The equation of motion for a small element between two neighboring cross sections of a tapered spoke-tube filled up with a liquid propellant is:

d(pA_{f})−d(σAₛ)=(ρ_{f}A_{f}+ρₛAₛ)ω²rdr (21)

We have already found the distribution of fluid pressure along the tube—it is given by (3). Now, let A_{f}≡A and Aₛ/A_{f}≡k. The next step in our spoke design is to search for a certain tapering function, A(r), that is consistent with both the uniform stress distribution, σ=σ_{T}, and a uniform tube cross-sectional area ratio Aₛ/A_{f} (i.e. with k having some constant value).

After a few substitutions, equation (21) takes the form:

dA/A=−2kρₛω²rdr/(2kσ_{T}−ρ_{f}ω²r²) (22)

With the boundary condition, A|ᵣ₌₀=A₀, the solution of this equation is:

A(r)=A₀[1−(1/κ)(V_{f}/V_{c})²(r/R)²]^{κ} (23)

where κ≡kρₛ/ρ_{f}, V_{c}=√(2σ_{T}/ρₛ), and Vₜ=ωR.

Finally, applying this solution to the spoke tip, A|_{r=R}=A_{R}, we get the tip velocity as a function of tube geometry and material properties:

Vₜ=V_{c}√{κ[1−(A_{R}/A₀)^{1/κ}]} (24)

### Replacing the Spoke Head with a Spoke Cap

The net longitudinal tensile force at the spoke end is able to hold both the fluid pressure, p_{R}, which is pressing the tube end, and an object of certain mass, mₛₕ, against the spoke tip acceleration:

kA_{R}σ_{T}=A_{R}p_{R}+mₛₕVₜ²/R (25)

This object is called the spoke head. Substituting p_{R} according to (4) yields the mass of the spoke head:

mₛₕ=(1/λ−1)ρ_{f}RA_{R}/2 (26)

where λ≡(1/κ)(Vₜ/V_{c})².

The next step in the spoke design is to replace the spoke head with a spoke cap in the form of a thick hemisphere of mass m (FIG. 3 and FIG. 4):

m_{sc}=(2π/3)ρₛ[(k+1)^{3/2}−1](D_{iR}/2)³ (27)

Since the spoke cap weighs less than the spoke head, this replacement results in some reduction of the target uniform stress, σ_{T}, we have started the spoke design with. The stress reduction is relatively small at the spoke base and rather large at the tip, with the following resultant tensile stress distribution:

σ(r)={1−2λ(mₛₕ−m_{sc})/[ρ_{f}A(r)R]}σ_{T} (28)

Substituting (26) into (28) and taking into account that m_{sc} is significantly less than mₛₕ (Table 4), tensile stress distribution function (28) is reduced to:

σ(r)=[1−(1−λ)A_{R}/A(r)]σ_{T} (29)

In particular, the relative value of the tensile stress reduction at the spoke base due to the spoke head replacement with the spoke cap is given by:

(σ_{T}−σ₀)/σ_{T}=(1−λ)A_{R}/A₀ (30)

### Accounting for the Bending Stress

Both the Coriolis force, associated with the flow of fluid inside the spoke-tube, and the reaction force of the fuel jet produce some additional stress in the spoke-tube, which has a bending effect at every spoke cross section. To be thorough in our spoke design for load-carrying capacity, we need to make sure that the peak value of this bending stress (attained, evidently, at the spoke base) does not exceed the reduction of tensile stress gained with the replacement of the heavy spoke head with the lightweight spoke cap. As we have seen earlier, the combined bending torque, T_{b}, of these two forces is given by:

T_{b}=T_{c}+Tₜ=2Tₜ=2(RVₜ/N)dm/dt=−2ρ_{f}AₙₒRVₜ²=−(π/2)ρ_{f}R(DₙₒVₜ)² (31)

The bending stress distribution across the spoke base is given by the beam flexure formula:

σ_{b}=−yT_{b}/Iₛ₀ (32)

The y term here is the distance from the spoke's axis; the Iₛ₀ term is the area moment of inertia of the spoke cross section at the base:

Iₛ₀=(π/4)[(Dₑ₀/2)⁴−(Dᵢ₀/2)⁴] (33)

The bending stress distribution has its peak value reached at y =Dₑ₀/2. Since (Dₑ₀/2)⁴>>(Dᵢ₀/2)⁴, we have:

σ_{bmax}=T_{b}(4/π)/(Dₑ₀/2)³=2ρ_{f}R(DₙₒVₜ)²/(Dₑ₀/2)³ (34)

Calculations carried out with a typical set of design parameters (Table 4) show that σ_{bmax} does not, indeed, exceed anywhere the reduction of the spoke tensile stress gained by the replacement of the spoke head with the spoke cap.

### Criterion for Deciding on the Tube's Cross-Sectional Area Ratio

Finally, we need to take a close look at the overall load in the tip region of the spoke and make sure that this load does not result in spoke failure. The stress-strain condition of the spoke in the tip region is essentially that of a thick cylindrical pipe that is closed at the ends and subjected to high internal pressure. According to the von Mises yield criterion, the highest internal pressure, p_{duc}, a cylindrical pipe can sustain under such conditions is given by the following expression:

p_{duc}=(2σ_{T}/√3)ln(D_{eR}/D_{iR}) (35)

where D_{eR} and D_{iR} are the external and internal diameters of the tube, respectively; p_{duc} is the pressure that lands the pipe cross-section in its entirety in the ductile region, and as such, it is the absolute maximum the pipe can withstand without bursting. Strength analysis based on p_{duc} has zero margin of safety; operating the rollet device under such an extreme load is clearly unacceptable. Practically acceptable load must necessarily be some fraction of p_{duc}, and it is determined by the desired margin of safety.

Substituting √(k +1) for the ratio D_{eR}/D_{iR} in (35) yields:

p_{duc}=(σ_{T}/√3)ln(k+1) (36)

The way we have designed spoke tapering (23) guaranties that the spoke can withstand the combined load of fluid pressure and tensile stress everywhere along its length provided it can withstand this load in the tip region, that is, if p_{R}≦p_{duc}:

(1/√3)ln(k+1)−k[1−(A_{R}/A₀)^{1/(kρ}^{ₛ}^{/p}^{_{f}}⁾]≧0 (37)

This is the criterion that determines the acceptable values for the tube cross-sectional area ratio, k, given the density ratio, ρₛ/ρ_{f}, and the tube taper ratio, A_{R}/A₀. The minimum value of k that satisfies the above inequality is called the critical cross-sectional area ratio of the spoke-tube. This important hydraulic rollet design parameter is to be computed as the root of the following equation:

(1/√3)ln(k+1)−k[1−(A_{R}/A₀)^{1/(kρ}^{ₛ}^{/ρ}^{_{f}}⁾]=0 (38)

### Accounting for Hydraulic Shock

In the rollet propulsion system, fuel ejection takes place in pulses—one fuel discharge pulse from each spoke-tube per wheel revolution. Each closure of the fuel release control valve, located near the exhaust nozzle inlet, will result in a hydraulic shock wave propagating from the tip of the spoke towards the fuel tank. Fairly accurate estimate of the pressure surge associated with the hydraulic shock is given by the Joukowsky equation:

ρΔp=ρ_{f}cΔu (39)

where c is the speed of sound in the fluid, and Δu is the fluid velocity change due to the valve closure. In the case of a regular water pipe of fixed diameter, the fluid velocity change would be the same along the pipe; therefore, the intensity of the pressure surge would also be invariant along the pipe. But in the case of tapered spoke-tubes, the pressure surge must necessarily vary—having the highest value at the spoke tip and gradually decreasing as the shock wave approaches the fuel tank:

Δp(r)=ρ_{f}cΔu(r) (40)

Whether the water-hammer effect is a serious concern in the context of hydraulic rollet design or not depends on the relative value of the pressure surge at the spoke end, Δp_{R}/p_{R}. Calculations with a typical design input parameters show that the pressure surge is less than 1% of the value of the hydrostatic pressure at the spoke tip (Table 5). Therefore, accounting for the water-hammer effect does not impose restrictions of any significance on the range of admissible design input parameters.

Nevertheless, a second valve, located at the spoke base, might be necessary in certain cases to smooth out and mitigate unwanted fluid pressure fluctuations, thereby reducing the risk of having resonant vibration or material fatigue problems. Closing this second valve in sync with the closure of the first valve would result in two shock waves locked between the valves—a compression wave, coming from the first valve, and an expansion wave, running from the second valve towards the spoke end. The two waves would meet then somewhere in between neutralizing each other and providing for a smother and safer operation of the rollet device. Closing the second valve at the spoke base would generate, of course, yet another compression shock wave propagating toward the fuel tank. The design of the fuel tank has to provide protection from harmful effects, if any, of this, relatively weak, shock wave.

### A Case Study of Spoke-Tube Design

To get a good idea of the magnitude of the effective exhaust velocity that can be attained realistically in the hydraulic rollet propulsion system, a case study is given below. The design case study is based on the commercially available material Zylon® AS. The list of design input parameters is given in Table 1. The results of the calculations are presented in Table 2.

TABLE 1

| Design Parameter | Symbol | Value | Dimension |
|---|---|---|---|
| Number of rollet wheels | N | 2 | — |
| Tensile strength of tube material | σ_{T} | 5.8 | GPa |
| (Zylon ® AS) | | | |
| Density of tube material (Zylon ® AS) | ρₛ | 1540 | kg/m³ |
| Density of propellant (water) | ρ_{f} | 1000 | kg/m³ |
| Radius of rollet wheels | R | 8 | m |
| Inside tube diameter at the spoke tip | D_{iR} | 3 | cm |
| Inside tube diameter at the spoke base | Dᵢ₀ | 12 | cm |
| Nozzle outlet diameter | Dₙₒ | 1 | mm |
| Nozzle inlet diameter | Dₙᵢ | 10 | mm |

TABLE 2

| Parameter/Variable | Symbol | Defined As | Calculated As | Value | |
|---|---|---|---|---|---|
| Characteristic velocity | V_{c} | √(2σ_{T}/ρₛ) | √(2σ_{T}/ρₛ) | 2744 | m/s |
| Density ratio | — | ρₛ/ρ_{f} | ρₛ/ρ_{f} | 1.54 | |
| Inner tube cross-sectional | A_{R} | — | π(D_{iR}/2)² | 7.068 | cm² |
| area at spoke tip | | | | | |
| Inner tube cross-sectional | A₀ | — | π(Dᵢ₀/2)² | 113.1 | cm² |
| area at spoke base | | | | | |
| Spoke-tube taper ratio | — | A_{R}/A₀ | A_{R}/A₀ | 0.0625 | |
| Spoke-tube cross- | k | Aₛ/A_{f} | See equation (38) | 18.5 | |
| sectional area ratio | | | | | |
| Auxiliary parameter | [symbol] | kρₛ/ρ_{f} | kρₛ/ρ_{f} | 28.5 | |
| Auxiliary variable | — | Vₜ/V_{c} | See equation (24) | 1.625 | |
| Spoke tip velocity | Vₜ | — | V_{c}(Vₜ/V_{c)} | 4460 | m/s |
| Exhaust collimation factor | C_{θ} | — | sin(π/8)/(π/8) | 0.975 | |
| Effective exhaust velocity | Vₑ | C_{θ}(Vₜ + V_{d}) | 2C_{θ}Vₜ | 8698 | m/s |
| Spin frequency of wheels | — | — | Vₜ/(2πR) | 88.7 | Hz |
| The power required to | P | — | 2ρ_{f}QNVₜ² | 138.9 | MW |
| operate hydraulic rollet in | | | (Q is defined in | | |
| continuous regime | | | Table 3) | | |
| Solar cell output | P_{sc} | — | — | 500 | W/m² |
| Solar power collector aria | — | — | P/P_{sc} | 0.278 | km² |

The effective exhaust velocity of 8698 m/s that can be achieved with commercially available Zylon® AS fibers is about twice the exhaust velocity attained by the best chemical rockets. It should be noted here that this result is based on the strength analysis of zero margin of safety, so, operating the hydraulic rollet at exhaust velocities near this peak theoretical value would be unacceptable. Nevertheless, operating the hydraulic rollet in the range of ¾ to ⅔ of the theoretical limit for exhaust velocity would have a reasonable margin of safety, and deliver yet an exhaust velocity appreciably higher than that of any chemical rocket.

This particular instance of hydraulic rollet, operating at half of its exhaust velocity limit, would require 34.8 MW of electrical power to drive it in the continuous regime. This translates to 0.069 km² of collector area required to generate that much electrical power with 500 W/m² of assumed solar cell output. With less than 34.8 MW of electrical power available, the hydraulic rollet must operate in the pulse regime.

The mathematical analysis of the rollet propulsion system given herein involved some assertions, thereby simplifying some of the equations that lie at the foundation of hydraulic rollet design. For example, we have described the flow of liquid as a turbulent flow of incompressible inviscid fluid based on the assertion that Reynolds number is typically well over 10⁴ for the water flow inside the spoke-tubes; another assertion was that the bending stress in the tapered spoke is less than the reduction of the tensile stress gained by replacing the spoke head with a spoke cap.

Tables 3 to 5 present the results of calculations made with the express purpose of backing up these assertions.

TABLE 3

| Parameter/Variable | Symbol | Defined As | Calculated As | Value | |
|---|---|---|---|---|---|
| Kinematic viscosity of | ν | — | — | 1.004 × 10⁻⁶ | m²/s |
| water (20° C.) | | | | | |
| Nozzle outlet diameter | Aₙₒ | — | π(Dₙₒ/2)² | 0.785 | mm² |
| Volumetric flow rate | Q | AₙₒVₜ | AₙₒVₜ | 3.50 | dm³/s |
| Fluid flow velocity at | u_{R} | Q/A_{R} | Q/A_{R} | 4.96 | m/s |
| spoke tip | | | | | |
| Fluid flow velocity at | u₀ | Q/A₀ | Q/A₀ | 0.31 | m/s |
| spoke base | | | | | |

| | | | | |
|---|---|---|---|---|
| Reynolds number at | Re | u_{R}D_{iR}/ν | u_{R}D_{iR}/ν | 1.48 × 10⁵ |
| spoke tip | | | | |
| Reynolds number at | Re | u₀Dᵢ₀/ν | u₀Dᵢ₀/ν | 0.37 × 10⁵ |
| spoke base | | | | |

TABLE 4

| Parameter/Variable | Symbol | Defined As | Calculated As | Value | |
|---|---|---|---|---|---|
| Auxiliary variable | λ | (1/ [symbol] )(Vₜ/V_{c})² | (1/ [symbol] )(Vₜ/V_{c})² | 0.0927 | |
| Mass of the spoke head | mₛₕ | — | See equation (26) | 27.67 | kg |
| Mass of the spoke cap | m_{sc} | — | See equation (27) | 0.93 | kg |
| Volumetric capacity of | Vᵢₙₜ | — | [symbol] | 47.86 | dm³ |
| spoke-tube interior | | | | | |
| Mass of water to fill up | — | — | ρ_{f}Vᵢₙₜ | 47.86 | kg |
| one spoke-tube | | | | | |
| Mass of one empty | — | — | kρₛVᵢₙₜ | 1363 | kg |
| spoke-tube | | | | | |
| External diameter of the | Dₑ₀ | — | 2√[(k + 1)A₀/π] | 0.53 | m |
| spoke at the base | | | | | |

| | | | | |
|---|---|---|---|---|
| Tensile stress reduction | — | (σ_{T} − σ₀)/σ_{T} | See equation (30) | 0.056 |
| at the spoke base | | | | |
| Peak value of bending | — | σ_{bmax}/σ_{T} | See equation (34) | 0.026 |
| stress at the spoke base | | | | |

TABLE 5

| | | Defined | Calculated | | |
|---|---|---|---|---|---|
| Parameter/Variable | Symbol | As | As | Value | |
| Speed of sound in water | c | — | — | 1500 | m/s |
| Water pressure at nozzle | p_{R} | — | ρ_{f}Vₜ²/2 | 9.95 | GPa |
| inlet | | | | | |
| Pressure surge at spoke | — | Δp_{R}/p_{R} | ρ_{f}u_{R}c/p_{R} | 0.00078 | |
| end (relative value) | | | | | |
| Pressure surge at spoke | Δp₀ | — | ρ_{f}u₀c | 4.67 | atm |
| base (absolute value) | | | | | |

1. In-space propulsion method based on the principles of inverted sling and separation of propulsion energy from reaction mass wherein high pressures of the propellant required for attaining high exhaust velocities are achieved not by burning a fuel but by centrifugal forces acting on the fluid in tapered spoke-tubes of two large wheels rotating in opposite directions, and each spoke-tube is equipped at the tip with a conoid nozzle for releasing the propellant wherein the jets of propellant from spoke-tubes of both wheels are orchestrated and collimated in such a way as to propel the spacecraft in certain direction.

2. Hydraulic propulsion system based on the propulsion method of claim 1, wherein water is been used as a propellant and the wheels are driven electrically by nuclear or solar power.
